(19) United States
(12) Patent Application Publication
(10) Pub. No.: US 2013/0016063 A1
(43) Pub. Date: Jan. 17, 2013

(54) CAPACITIVE TOUCH PANEL

(71) Applicant: Jane HSU, Guishan Township (TW)

(72) Inventor: Jane HSU, Guishan Township (TW)

(73) Assignee: DerLead Investment Ltd., Taipei (TW)

(21) Appl. No.: 13/542,388

(22) Filed: Jul. 5, 2012

(30) Foreign Application Priority Data
Jul. 12, 2011 (TW) 100212733

(51) Int. Cl. G06F 3/044

(52) U.S. Cl. 345/174

(57) ABSTRACT

A capacitive touch panel has a transparent substrate and an ink layer. The transparent substrate has an indium tin oxide (ITO) layer and a lead wire region. The ITO layer is mounted on a bottom surface of the transparent substrate and has multiple electrodes mounted thereon. The lead wire region is formed on a bordering portion of the bottom surface of the transparent substrate and has multiple lead wires mounted thereon and electrically connected to the electrodes. The ink layer is mounted on a top surface of the transparent surface and corresponds to the lead wire region. Accordingly, the lead wires do not aesthetically affect the capacitive touch panel, downstream manufacturers are not required to mount a bonding layer and a protection layer, thereby not only saving the manufacturing process and material cost but also reducing the overall thickness of electronic devices using the capacitive touch panel.

### BACKGROUND OF THE INVENTION

1. Field of the Invention

The present invention relates to a touch panel and more particularly to a capacitive touch panel.

2. Description of the Related Art

To keep abreast with the technological development of touch panels, portable electronic devices, such as smart phones, tablet personal computers (PC), media players (MP5) and the like, all adopt touch panels to replace conventional mechanical keyboards, which are more room-consuming, nowadays.

Current touch panels that are oftentimes used in portable electronic devices mostly pertain to capacitive touch panels. With reference to FIG. 8, a conventional touch panel 60 has a transparent substrate 61, an indium tin oxide (ITO) layer 62, a lead wire segment 63 and multiple electrodes 64. The ITO layer 62 is mounted on a bottom surface of the transparent substrate 61. The lead wire segment 63 is formed on a bordering portion of the bottom surface of the transparent substrate 61 and has multiple lead wires 65 mounted thereon. The electrodes 64 are mounted on the ITO layer 62 and are electrically connected to the electrodes 64. As the foregoing lead wires are non-transparent, with reference to FIG. 9, manufacturers of electronic devices need to paint an ink layer 71 on a bordering portion of a bottom surface of a protection layer 70, and a bonding layer 72 is mounted on a top surface of the touch panel 60 and is adhered to the protection layer 70 so that the ink layer 71 on the bottom surface of the protection layer 70 corresponds to the lead wire region 63 of the touch panel 60 and masks the lead wires 65 on the lead wire region of the touch panel 60. However, the use of ink layer 71 and the bonding layer 72 not only introduce overhead arising from additional manufacturing processes and material cost, but also increase the overall thickness of electronic devices, thereby failing to fulfill the light, thin and compact requirements of portable electronic devices.

### SUMMARY OF THE INVENTION

An objective of the present invention is to provide a capacitive touch panel having an ink layer directly mounted on the touch panel and getting rid of a bonding layer and a protection layer required in downstream manufacturing.

To achieve the foregoing objective, the capacitive touch panel has a transparent substrate and an ink layer.

The transparent substrate has a top surface, a bottom surface, an indium tin oxide (ITO) layer, a lead wire region and multiple lead wires.

The ITO layer is mounted on the bottom surface and has multiple electrodes mounted thereon.

The lead wire region is formed on a bordering portion of the bottom surface.

The lead wires are mounted on the lead wire region and electrically connected to the respective electrodes on the ITO layer.

The ink layer corresponds to the lead wire region and is mounted on the top surface of the transparent substrate.

Alternatively, the capacitive touch panel has a transparent substrate and a first ink layer.

The transparent substrate has a top surface, a bottom surface, an ITO layer and a lead wire region.

The ITO layer is mounted on the bottom surface and has multiple electrodes mounted thereon.

The lead wire region is formed on a bordering portion of the bottom surface.

The first ink layer is mounted on the lead wire region of the transparent substrate and has multiple lead wires electrically connected to the respective electrodes on the ITO layer.

When viewed from the top surface of the transparent substrate of the capacitive touch panel, the non-transparent first ink layer therefore blocks the lead wires on the lead wire region of the bottom surface of the transparent substrate. When downstream manufacturers manufacture electronic devices, the bonding layer and the protection layer are not necessary to be additionally mounted on the touch panel. Not only can the production process and material cost for manufacturing electronic device be reduced, but also the overall thickness of electronic devices can be thinner.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a first embodiment of a capacitive touch panel in accordance with the present invention;

FIG. 2 is a side view in partial section of the capacitive touch panel in FIG. 1;

FIG. 3 is a bottom view of the capacitive touch panel in FIG. 1 having a transparent substrate without an ink layer;

FIG. 4 is a bottom view of a second embodiment of a capacitive touch panel having a transparent substrate without an ink layer in accordance with the present invention;

FIG. 5 is a bottom view of a third embodiment of a capacitive touch panel having a transparent substrate with an ink layer in accordance with the present invention;

FIG. 6 is a side view in partial section of the capacitive touch panel in FIG. 5;

FIG. 7 is a bottom view of a fourth embodiment of a capacitive touch panel having a transparent substrate with an ink layer in accordance with the present invention;

FIG. 8 is a bottom view of a conventional capacitive touch panel; and

FIG. 9 is a side view in partial section of the conventional capacitive touch panel.

### DETAILED DESCRIPTION OF THE INVENTION

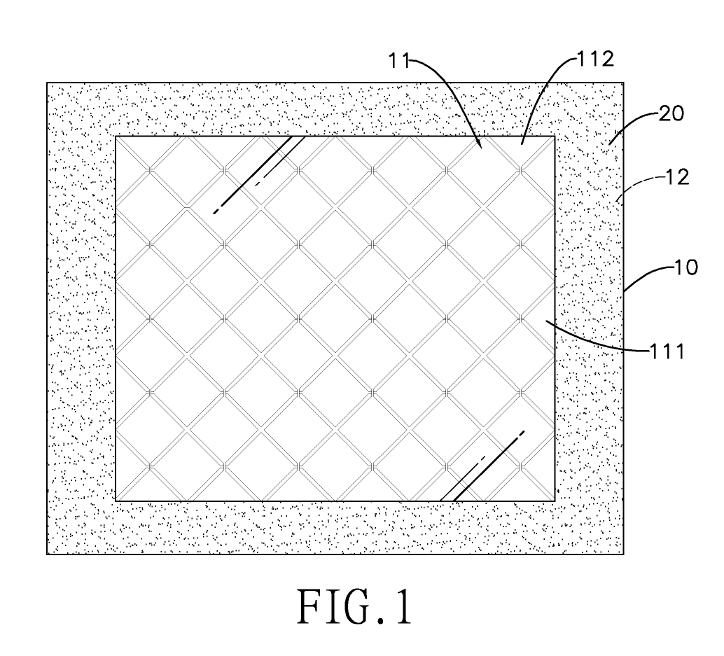

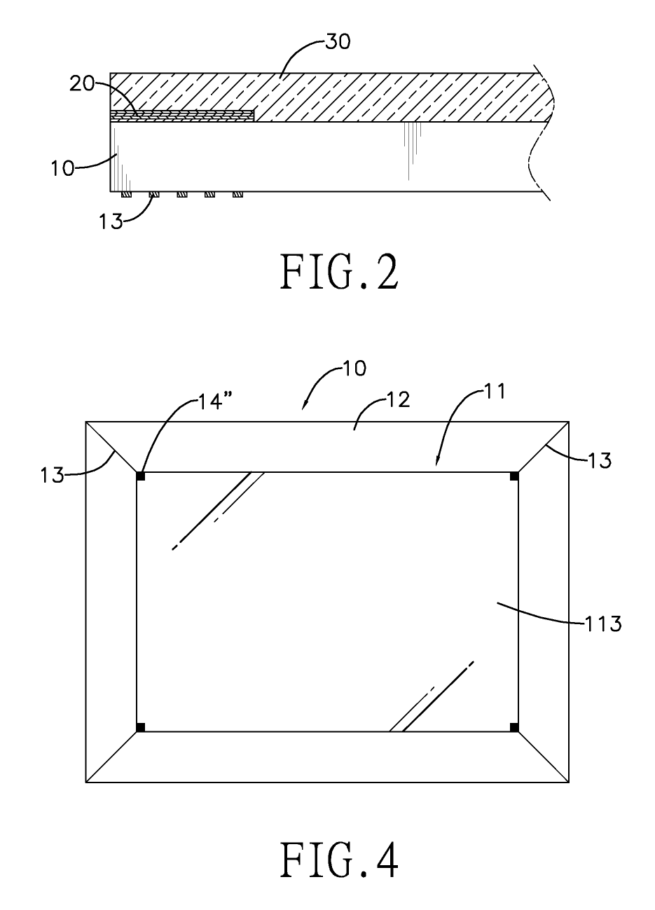

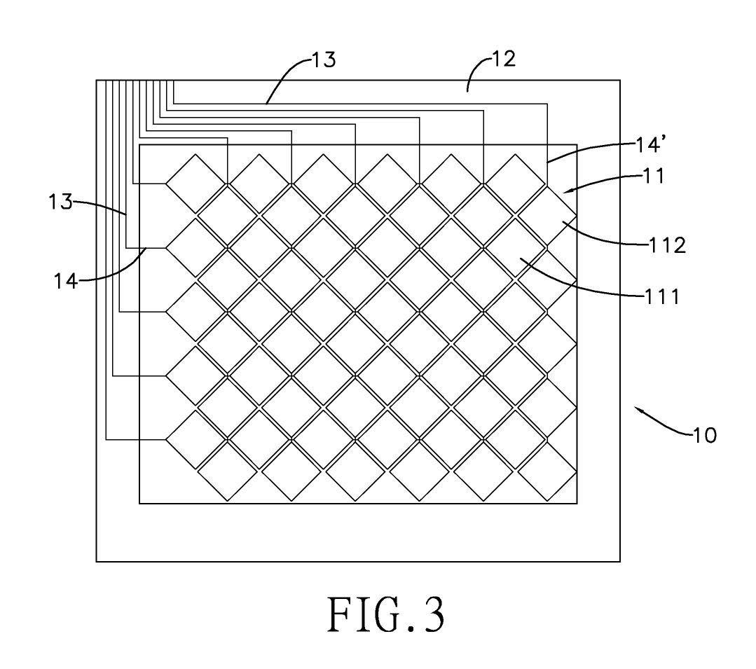

With reference to FIGS. 1 to 3, a first embodiment of a capacitive touch panel in accordance with the present invention has a transparent substrate 10, an ink layer 20 and a transparent paint layer 30.

The transparent substrate 10 has a top surface and a bottom surface, an ITO layer 11, a lead wire region 12 and multiple lead wires 13. The ITO layer 11 is mounted on the bottom surface of the transparent substrate 10 and has multiple electrodes mounted thereon. The lead wire region 12 is formed on a bordering portion of the bottom surface of the transparent substrate 10. The lead wires 13 are mounted on the lead wire segment 12 and electrically connected to the respective electrodes on the ITO layer 11. In the present embodiment, given a projected capacitive touch panel as an example, the ITO layer 11 has an X-axis sensing area 111 and a Y-axis sensing area 112. The X-axis sensing area 111 has multiple X-axis electrodes 14, and each X-axis electrode 14 is electrically connected to a corresponding lead wire 13. The Y-axis sensing area 112 has multiple Y-axis electrodes 14′, and each Y-axis electrode 14′ is electrically connected to a corresponding lead wire 13. With reference to FIG. 4, a second embodiment of a capacitive touch panel in accordance with the present invention is a surface capacitive touch panel. The ITO layer 11 of the touch panel constitutes a first sensing area 113. The first sensing area 113 has four sensing electrodes 14″ respectively mounted on four corners, and each sensing electrode 14″ is electrically connected to a corresponding lead wire 13.

The ink layer 20 corresponds to the lead wire region 12 of the transparent substrate 10 and is mounted on the top surface of the transparent substrate 10.

The transparent paint layer 30 is fully mounted on the top surface of the transparent substrate 10 and the ink layer 20 to level up a surface of the touch panel and to embellish the touch panel.

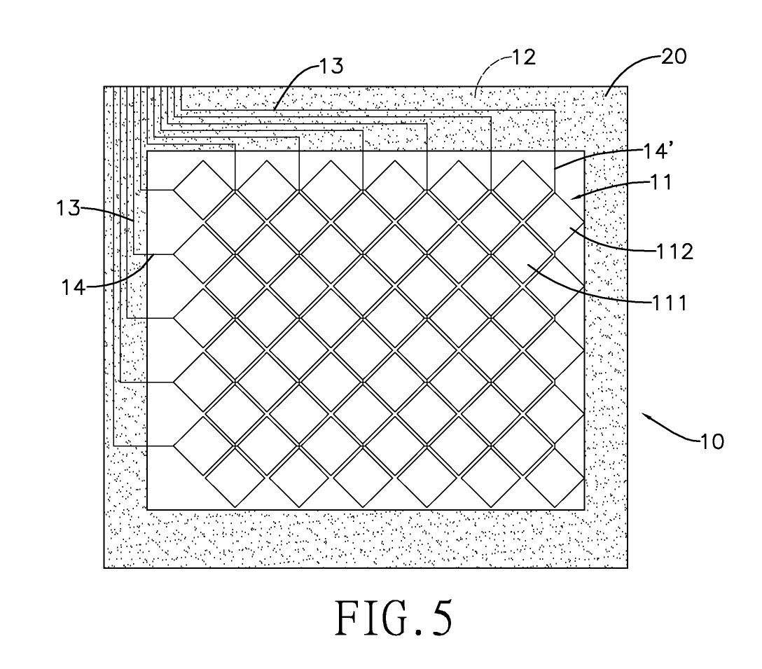

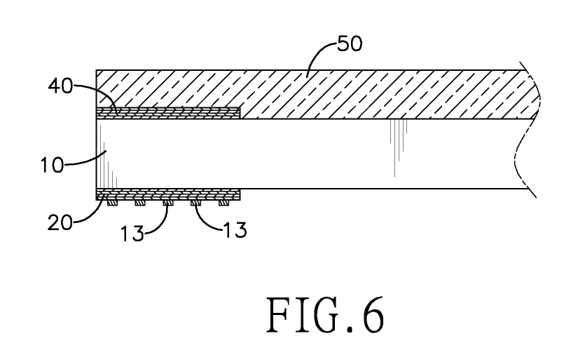

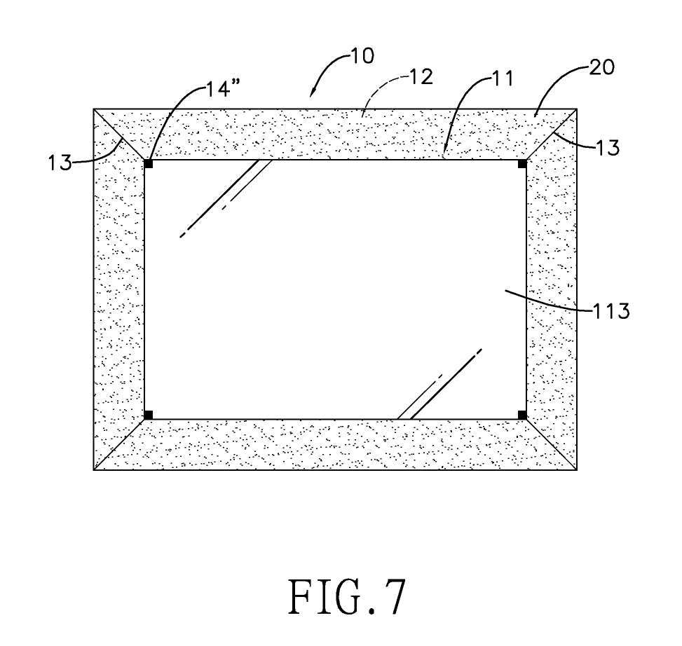

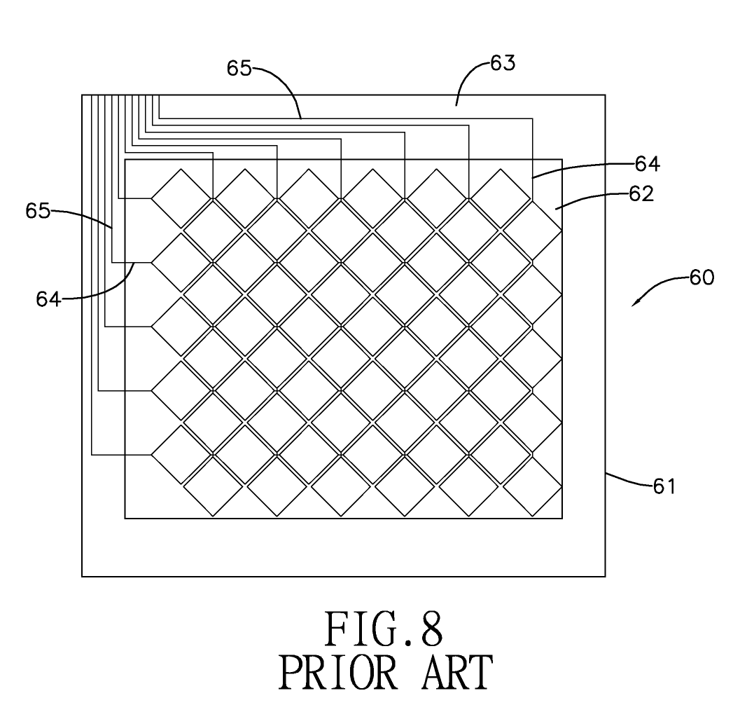

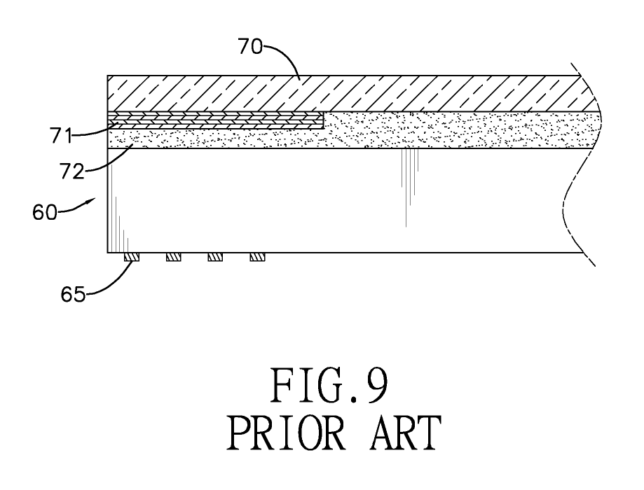

With reference to FIGS. 5 and 6, a third embodiment of a capacitive touch panel in accordance with the present invention and a fourth embodiment of a capacitive touch panel in accordance with the present invention are roughly the same as the first and second embodiment except that the ink layer 20 is mounted on the lead wire region 12 on the bottom surface of the transparent substrate 10, the lead wires 13 are formed on the ink layer 20, a second ink layer 40 is mounted on the top surface of the transparent substrate 10, and a transparent paint layer 50 is fully mounted on the top surface of the transparent substrate 10 and the second ink layer 40.

When viewed from the top surface of the transparent substrate 10 of the capacitive touch panel, the non-transparent ink layer 20 therefore blocks the lead wires on the lead wire region 11 of the bottom surface of the transparent substrate 10. When downstream manufacturers manufacture electronic devices, the bonding layer and the protection layer are not necessary to be additionally mounted on the touch panel. Not only can the production process and material cost for manufacturing electronic device be reduced, but also the overall thickness of electronic devices can be thinner. Accordingly, the light, thin and compact requirement of portable electronic devices can be met.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A capacitive touch panel comprising:
a transparent substrate having:
a top surface;
a bottom surface;
an indium tin oxide (ITO) layer mounted on the bottom surface and having multiple electrodes mounted thereon;
a lead wire region formed on a bordering portion of the bottom surface; and
multiple lead wires mounted on the lead wire region and electrically connected to the respective electrodes on the ITO layer; and
an ink layer corresponding to the lead wire region and mounted on the top surface of the transparent substrate.

2. The capacitive touch panel as claimed in claim 1, wherein the ITO layer constitutes:
an X-axis sensing area having multiple X-axis electrodes, each X-axis electrode electrically connected to a corresponding lead wire; and
a Y-axis sensing area having multiple Y-axis electrodes, each Y-axis electrode electrically connected to a corresponding lead wire.

3. The capacitive touch panel as claimed in claim 1, wherein the ITO layer constitutes a sensing area having four sensing electrodes respectively mounted on four corners of the sensing area, and each sensing electrode is electrically connected to a corresponding lead wire.

4. The capacitive touch panel as claimed in claim 1, wherein the transparent paint layer is fully mounted on the top surface of the transparent substrate and the ink layer.

5. The capacitive touch panel as claimed in claim 2, wherein the transparent paint layer is fully mounted on the top surface of the transparent substrate and the ink layer.

6. The capacitive touch panel as claimed in claim 3, wherein the transparent paint layer is fully mounted on the top surface of the transparent substrate and the ink layer.

7. A capacitive touch panel comprising:
a transparent substrate having:
a top surface;
a bottom surface;
an indium tin oxide (ITO) layer mounted on the bottom surface and having multiple electrodes mounted thereon; and
a lead wire region formed on a bordering portion of the bottom surface; and
a first ink layer mounted on the lead wire region of the transparent substrate and having multiple lead wires electrically connected to the respective electrodes on the ITO layer.

8. The capacitive touch panel as claimed in claim 7, wherein the ITO layer constitutes:
an X-axis sensing area having multiple X-axis electrodes, each X-axis electrode electrically connected to a corresponding lead wire; and
a Y-axis sensing area having multiple Y-axis electrodes, each Y-axis electrode electrically connected to a corresponding lead wire.

9. The capacitive touch panel as claimed in claim 7, wherein the ITO layer constitutes a sensing area having four sensing electrodes respectively mounted on four corners of the sensing area, and each sensing electrode is electrically connected to a corresponding lead wire.

10. The capacitive touch panel as claimed in claim 7, further comprising:
a second ink layer mounted on the top surface of the transparent substrate; and
a transparent paint layer fully mounted on the top surface of the transparent substrate and the second ink layer.

11. The capacitive touch panel as claimed in claim 8, further comprising:
a second ink layer mounted on the top surface of the transparent substrate; and
a transparent paint layer fully mounted on the top surface of the transparent substrate and the second ink layer.

12. The capacitive touch panel as claimed in claim 9, further comprising:
a second ink layer mounted on the top surface of the transparent substrate; and
a transparent paint layer fully mounted on the top surface of the transparent substrate and the second ink layer.
